(19) United States
(12) Patent Application Publication
(10) Pub. No.: US 2026/0258870 A1
(43) Pub. Date: Sep. 3, 2026

(54) Throttle Valve Control Device and Press Fit Structure

(71) Applicant: Hitachi Astemo, Ltd., Hitachinaka-shi, Ibaraki (JP)

(72) Inventors: Hidefumi HATSUZAWA, Hitachinaka-shi, Ibaraki (JP); Yuhei FUKUDA, Hitachinaka-shi, Ibaraki (JP); Takuya TANAKA, Hitachinaka-shi, Ibaraki (JP); Reiji BABA, Hitachinaka-shi, Ibaraki (JP)

(21) Appl. No.: 18/993,174

(22) PCT Filed: Aug. 12, 2022
(86) PCT No.: PCT/JP2022/030725

§ 371 Date: Jan. 10, 2025

(51) Int. Cl. F16K 1/22; F16K 27/02; F16K 31/04

(52) U.S. Cl. CPC F16K 1/221; F16K 27/0218; F16K 31/047; F16K 1/224

(57) ABSTRACT

The present disclosure provides a throttle valve control device and a press fit structure enabling relaxation of stress acting on a rotor into which a rotation shaft is press-fitted. The throttle valve control device and the press fit structure include a rotation shaft 103 and a rotor 130 that rotates integrally with the rotation shaft 103, and an insertion part 103a provided at one end of the rotation shaft 103 is press-fitted and fixed to an insertion hole 134 provided in the rotor 130. An outer peripheral surface of the insertion part 103a has a pair of convex curved surfaces 103c, a pair of flat surfaces 103d provided between the pair of convex curved surfaces 103c, and a plurality of ridge parts 103e formed at boundaries between the flat surfaces 103d and the convex curved surfaces 103c. An inner peripheral surface of the insertion hole 134 includes a pair of concave curved surfaces 134a fitted with the pair of convex curved surfaces 103c of the insertion part 103a, a pair of recesses 134b forming a space in between with the pair of flat surfaces 103d of the insertion part 103a and around each of the ridge parts 103e, and a rotation prevention part 134c protruding from a bottom surface of each of the recesses 134b and in contact with each of the flat surfaces 103d of the insertion part 103a.

### TECHNICAL FIELD

The present disclosure relates to a throttle valve control device and a press fit structure.

### BACKGROUND ART

Conventionally, inventions related to a throttle valve control device have been known. For example, the throttle valve control device described in PTL 1 below includes a throttle valve, a rotation shaft of the throttle valve, a rotating body into which the rotation shaft is inserted, the rotating body rotating by a transmission mechanism that transmits a driving force of a motor to rotate the rotation shaft, and a rotor provided coaxially with the rotating body (PTL 1, claim 8).

The above-described conventional throttle valve control device includes, at one end of the rotor, a rotating conductor provided coaxially with the rotor, a fixed conductor provided to be opposed to the rotating conductor, and an electronic circuit. The electronic circuit detects a rotation position of the rotating body by utilizing a fact that an inductance between the rotating conductor and the fixed conductor changes according to a position of the rotating conductor in a rotation direction. In addition, the rotor has different diameters at the rotating conductor side and the other side.

Since a highly reliable inductance type non-contact type rotation angle detection device is provided, the conventional throttle valve control device becomes a highly reliable motor-driven throttle valve control device enabling a predetermined sensor output to be obtained while achieving miniaturization (PTL 1, paragraph 0111).

### CITATION LIST

### Patent Literature

PTL 1: JP 2019-124527 A

### SUMMARY OF INVENTION

### Technical Problem

In the above-described conventional throttle valve control device, a convex part for fitting the rotor with a throttle shaft is formed on an inner diameter side on a flat part side of the rotor. With such a convex part, the rotor can be firmly fixed so as to be rotated together when the rotor is fixed to the throttle shaft by a nut (PTL 1, paragraph 0060, FIG. 1). This conventional throttle valve control device, however, has room for improvement in stress relaxation of the rotor fixed to the throttle shaft.

The present disclosure provides a throttle valve control device and a press fit structure enabling relaxation of stress acting on a rotor into which a rotation shaft is press-fitted.

### Solution to Problem

One aspect of the present disclosure is a throttle valve control device including: a valve body; a rotation shaft that rotates the valve body; and a rotor that rotates integrally with the rotation shaft, in which an insertion part provided at one end of the rotation shaft is press-fitted and fixed to an insertion hole provided in the rotor. An outer peripheral surface of the insertion part has a pair of convex curved surfaces which is a part of a columnar surface concentric with the rotation shaft, a pair of flat surfaces provided between the pair of convex curved surfaces, and ridge parts formed at boundaries between the flat surfaces and the convex curved surfaces, and an inner peripheral surface of the insertion hole has a pair of concave curved surfaces fitted with the pair of convex curved surfaces of the insertion part, a pair of recesses forming a space in between with the pair of flat surfaces of the insertion part and around each of the ridge parts, and a rotation prevention part protruding from a bottom surface of each of the recesses and in contact with each of the flat surfaces of the insertion part.

### Advantageous Effects of Invention

According to the above aspect of the present disclosure, it is possible to provide a throttle valve control device enabling relaxation of stress acting on a rotor into which a rotation shaft is press-fitted.

### BRIEF DESCRIPTION OF DRAWINGS

FIG. 1 is a perspective view illustrating an embodiment of a throttle valve control device according to the present disclosure.

FIG. 2 is a cross-sectional view of the throttle valve control device illustrated in FIG. 1.

FIG. 3 is an exploded perspective view of the throttle valve control device illustrated in FIG. 1.

FIG. 4 is an exploded perspective view of the throttle valve control device illustrated in FIG. 1.

FIG. 5 is a plan view of the throttle valve control device illustrated in FIG. 1 in a state where a gear cover is removed.

FIG. 6 is a perspective view of the gear cover of the throttle valve control device illustrated in FIG. 1.

FIG. 7 is a perspective view of a fixed board attached to the gear cover illustrated in FIG. 6.

FIG. 8 is an enlarged cross-sectional view of a rotor and one end of a rotation shaft of the throttle valve control device illustrated in FIG. 2.

FIG. 9 is an exploded perspective view of the rotor and the rotation shaft illustrated in FIG. 8.

FIG. 10 is a cross-sectional view of the rotor illustrated in FIG. 9.

FIG. 11 is a bottom view of the rotor illustrated in FIG. 9.

FIG. 12 is a perspective view of an insertion hole of the rotor illustrated in FIG. 11.

FIG. 13 is an enlarged cross-sectional view of the insertion hole of the rotor and an insertion part of the rotation shaft illustrated in FIG. 8.

### DESCRIPTION OF EMBODIMENTS

In the following, embodiments of a throttle valve control device and a press fit structure according to the present disclosure will be described with reference to the drawings.

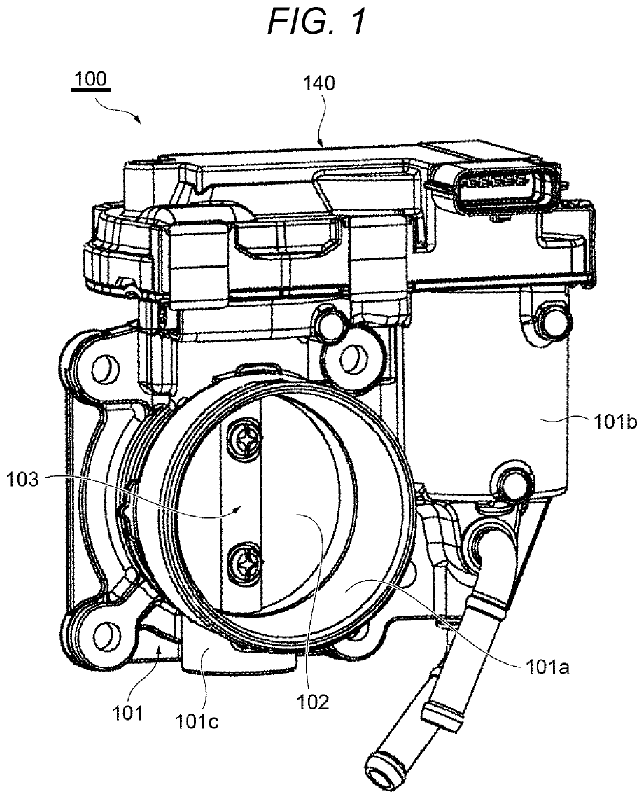

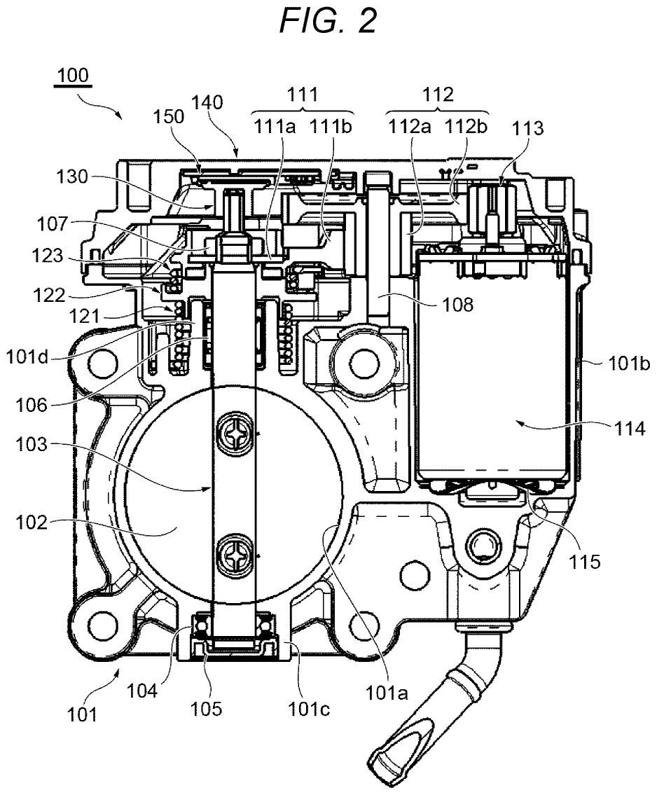

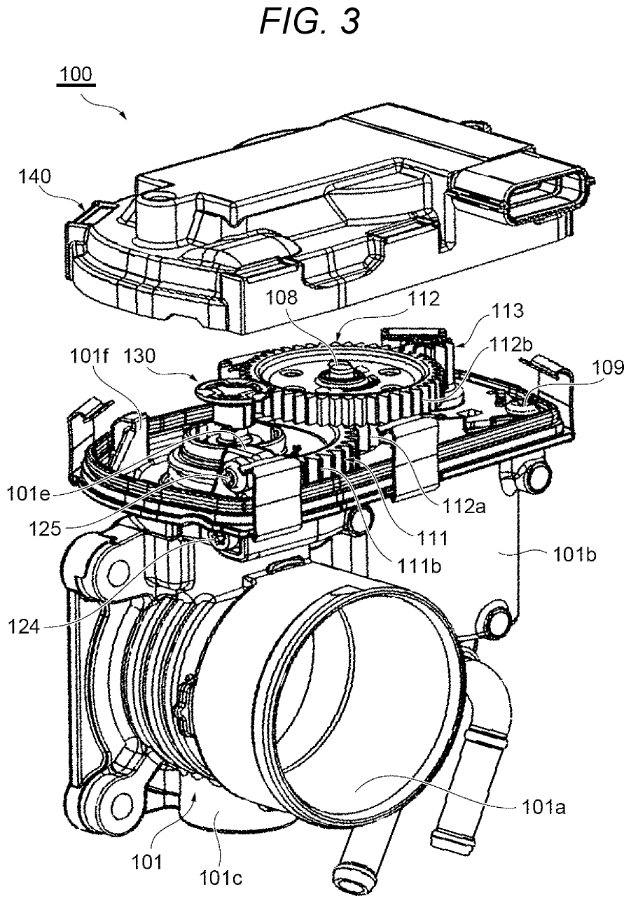

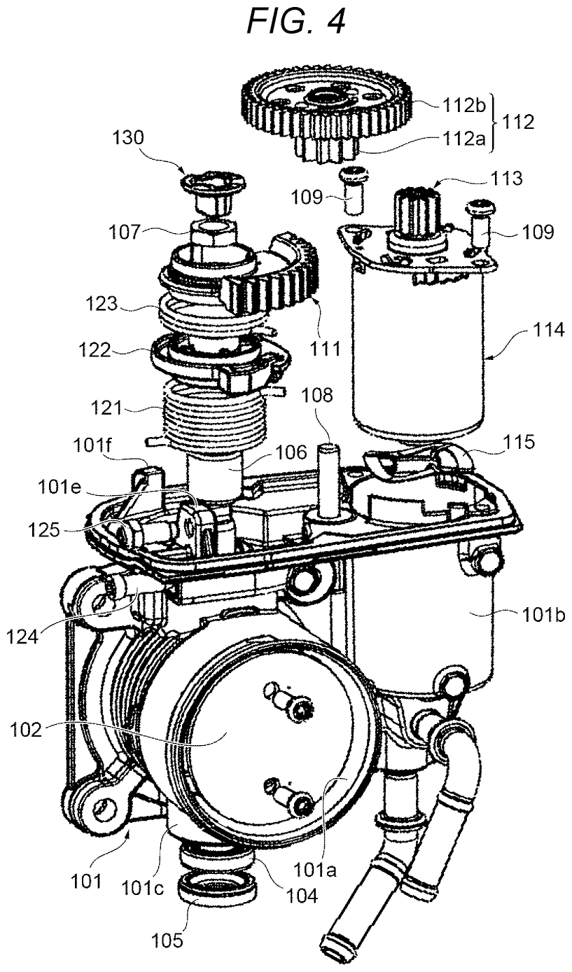

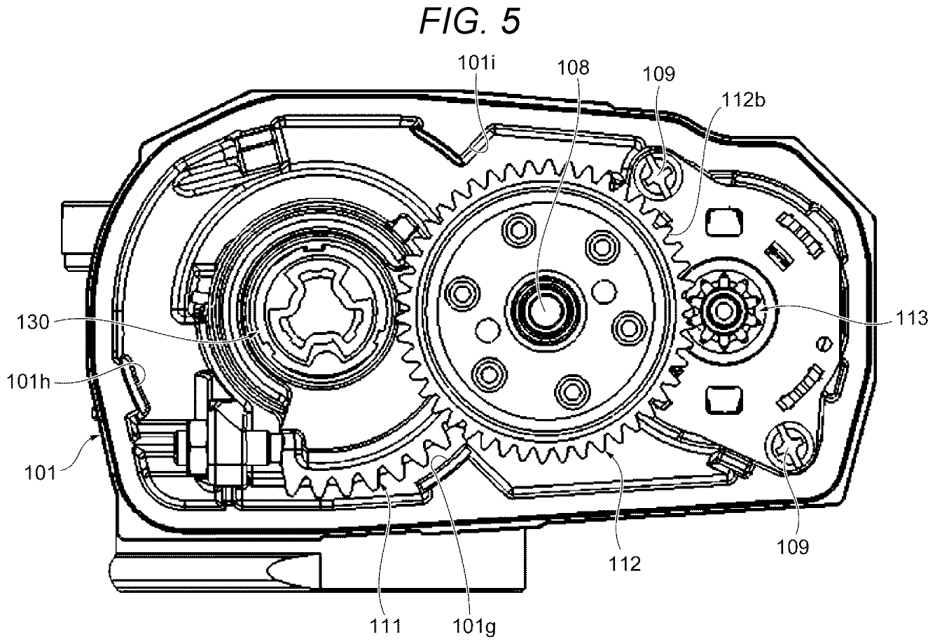

FIG. 1 is a perspective view illustrating an embodiment of a throttle valve control device according to the present disclosure. FIG. 2 is a cross-sectional view of a throttle valve control device 100 illustrated in FIG. 1. FIG. 3 is an exploded perspective view of the throttle valve control device 100 illustrated in FIG. 1 in a state where a gear cover 140 is removed. FIG. 4 is an exploded perspective view of a part of the throttle valve control device 100 illustrated in FIG. 3 excluding the gear cover 140. FIG. 5 is a plan view of the throttle valve control device 100 illustrated in FIG. 1 in the state where the gear cover 140 is removed.

In the following description, the embodiment of the press fit structure according to the present disclosure will be described in detail together with the throttle valve control device 100 of the present embodiment. The throttle valve control device 100 of the present embodiment is, for example, a motor-driven throttle valve control device mounted on an internal combustion engine vehicle. The throttle valve control device 100 includes, for example, a throttle body 101, a valve body 102, a rotation shaft 103, a ball bearing 104, a cap 105, and a needle bearing 106.

The throttle valve control device 100 also includes, for example, a throttle gear 111, an intermediate gear 112, a motor gear 113, a motor 114, a return spring 121, a default lever 122, and a default spring 123. The throttle valve control device 100 further includes, for example, a rotor 130, a gear cover 140, and a fixed board 150.

The throttle body 101 is, for example, a throttle valve assembly made of aluminum die-casting. In the throttle body 101, for example, a bore 101a constituting a part of a ventilation passage, a motor housing 101b, and bearing bosses 101c and 101d are integrally molded.

The valve body 102 is, for example, a metallic disk-shaped member, is inserted into a slit provided in the rotation shaft 103 also called a throttle shaft, and is fixed to the rotation shaft 103 by a screw. The valve body 102 is disposed in the bore 101a and rotates together with the rotation shaft 103 to open and close the bore 101a. The rotation shaft 103 is, for example, a round bar-shaped member made of metal, and penetrates the cylindrical bore 101a so as to pass through the center of the bore 101a.

For example, the ball bearing 104 is press-fitted and fixed to the bearing boss 101c of the throttle body 101, and supports an end on a side opposite to one end of the rotation shaft 103 to which the rotor 130 and the throttle gear 111 are fixed so as to be rotatable about the axis. For example, the cap 105 is press-fitted into an opening of the bearing boss 101c of the throttle body 101 to airtightly seal the opening of the bearing boss 101c, and cover the ball bearing 104 and the end of the rotation shaft 103 from the outside.

The needle bearing 106 is press-fitted into the bearing boss 101d of the throttle body 101, and supports the rotation shaft 103 so as to be rotatable about the axis, for example, on a side opposite to the ball bearing 104 with respect to the bore 101a and the valve body 102. The needle bearing 106 seals an opening of the bearing boss 101d, and constitutes a shaft seal part together with the ball bearing 104 and the cap 105. This secures airtightness and liquid tightness of the bearing boss 101c at which the ball bearing 104 and the cap 105 are disposed and the bearing boss 101d at which the needle bearing 106 is disposed.

For example, the throttle gear 111 is disposed adjacent to the needle bearing 106 side of the rotor 130 at one end of the rotation shaft 103 to which the rotor 130 is fixed, and is fixed to the rotation shaft 103. The throttle gear 111 has, for example, a metal plate 111a and a gear part 111b made of resin and molded integrally with the metal plate 111a.

The throttle gear 111 is fixed to the rotation shaft 103 in the following procedure, for example. First, one end of the rotation shaft 103 is inserted into an attachment hole provided in a central part of the metal plate 111a, and an enlarged diameter part of the rotation shaft 103 having an outer diameter larger than that of the one end is lightly press-fitted into the attachment hole of the metal plate 111a. In this state, a nut 107 is screwed to a screw of the enlarged diameter part of the rotation shaft 103, whereby the throttle gear 111 is fixed to the rotation shaft 103.

For example, as illustrated in FIG. 2, the intermediate gear 112 is attached rotatably around the axis with respect to a gear shaft 108 press-fitted and fixed in an attachment hole of the throttle body 101. The intermediate gear 112 has, for example, a small-diameter gear 112a that meshes with the gear part 111b of the throttle gear 111, and a large-diameter gear 112b that meshes with the motor gear 113.

The motor gear 113 is fixed, for example, to a rotation shaft of the motor 114 and rotates together with the rotation shaft of the motor 114. When the motor gear 113 rotates, the intermediate gear 112 having the large-diameter gear 112b meshing with the motor gear 113 rotates, and the throttle gear 111 meshing with the small-diameter gear 112a of the intermediate gear 112 rotates. The motor gear 113, the intermediate gear 112, and the throttle gear 111 constitute a reduction gear mechanism of the throttle valve control device 100.

The motor 114 is, for example, a brush type DC motor, and as illustrated in FIGS. 2 and 4, the motor 114 is accommodated in the cylindrical motor housing 101b of the throttle body 101 such that the rotation axis of the motor 114 is parallel to the rotation shaft 103 of the valve body 102. The motor 114 is fixed to the throttle body 101 by, for example, screwing a screw 109 inserted through a through hole of a bracket into a screw hole of the throttle body 101. In addition, for example, a wave washer 115 is disposed between a bottom of the motor housing 101b and a bottom of the motor 114 to hold the motor 114.

The return spring 121 is, for example, a helical spring disposed around the bearing boss 101d of the throttle body 101, and has one end held by a notch of the throttle body 101 and the other end held by a hook part of the default lever 122.

The default lever 122 has an initial position mechanically decided by bringing an end of the default lever 122 into contact with the default screw 124 shown in FIGS. 3 and 4. The default screw 124 is screwed into, for example, the screw hole provided in the throttle body 101.

The default spring 123 is a helical spring disposed on the side of the default lever 122 opposite to the return spring 121. The default spring 123 has one end held by the hook part of the default lever 122 and the other end held by a hook part of the throttle gear 111.

The throttle gear 111 is biased by, for example, the return spring 121, the default lever 122, and the default spring 123, and the throttle gear 111 has one end held in contact with a fully closing screw 125 shown in FIGS. 3 and 4. In this state, the valve body 102 fixed to the rotation shaft 103 that rotates integrally with the throttle gear 111 is held at a fully closing position of closing the bore 101a.

For example, the fully closing screw 125 is screwed to a protruding fully closing boss 101e provided integrally with the throttle body 101. For example, as illustrated in FIGS. 3 and 4, the throttle body 101 has a protruding fully opening stopper 101f provided integrally with the throttle body 101.

The throttle gear 111 rotates, for example, by the intermediate gear 112 that transmits power of the motor 114, in a direction in which one end of the gear part 111b goes away from the fully closing screw 125 against a biasing force of the return spring 121 and the default spring 123. The rotation of the throttle gear 111 is restricted by the other end of the gear part 111b coming into contact with the fully opening stopper 101f. In this state, the valve body 102 fixed to the rotation shaft 103 that rotates integrally with the throttle gear 111 is held at a fully opening position where an opening area of the bore 101a is maximized.

With the above configuration, in the throttle valve control device 100, when the rotation shaft of the motor 114 is rotated at the fully closing position of the valve body 102, the rotation shaft 103 is rotated by the reduction gear mechanism including the motor gear 113, the intermediate gear 112, and the throttle gear 111. This enables the throttle valve control device 100 to control the opening area of the bore 101a by keeping the valve body 102 at an arbitrary angle between the fully closing position and the fully opening position, and to control an intake air amount to an engine by changing a cross-sectional area of an intake passage.

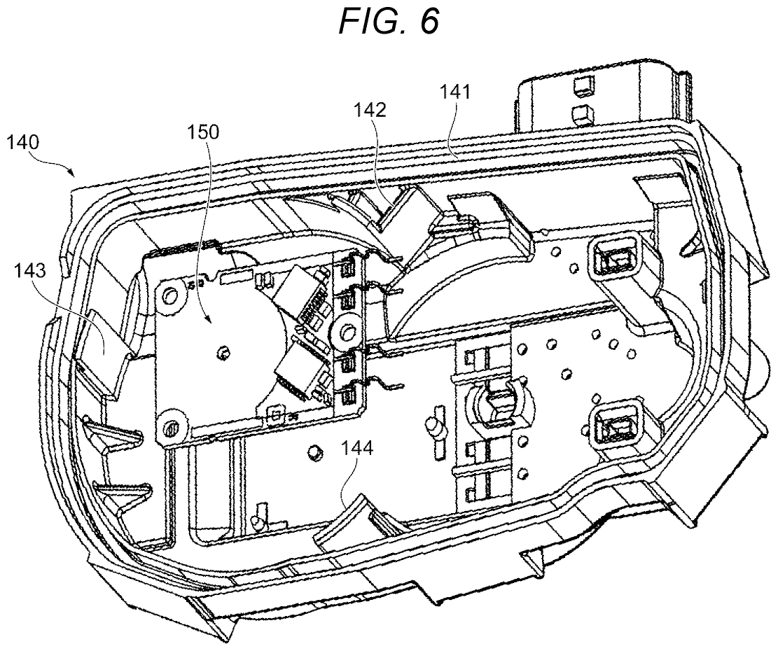

Next, a configuration of an inductive throttle sensor that detects a rotation angle of the rotation shaft 103 in the throttle valve control device 100 of the present embodiment will be described in detail with reference to FIGS. 6 to 13.

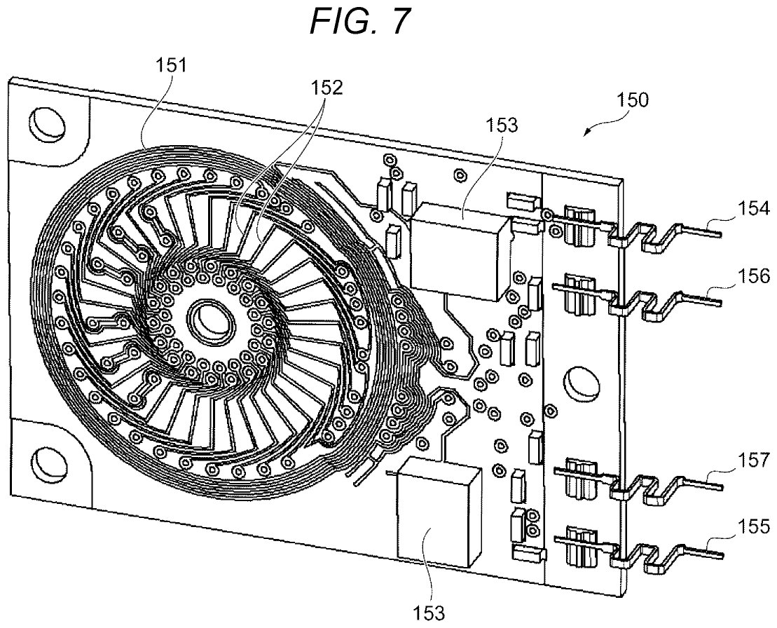

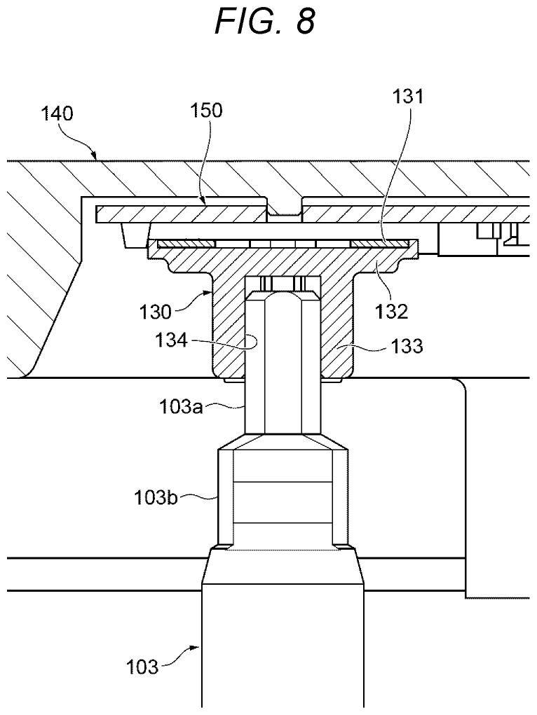

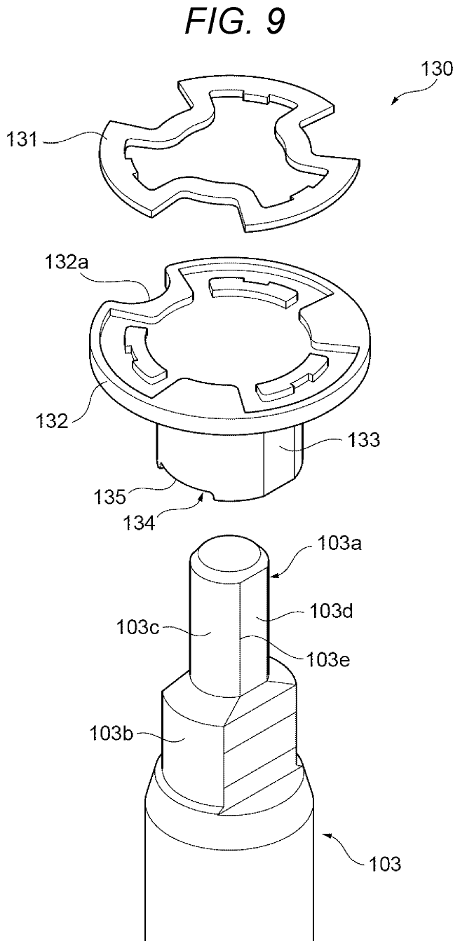

FIG. 6 is a perspective view of the vertically inverted gear cover 140 of the throttle valve control device 100 illustrated in FIG. 1. FIG. 7 is a perspective view illustrating an example of the fixed board 150 attached to the gear cover 140 illustrated in FIG. 6. FIG. 8 is an enlarged cross-sectional view of the rotor 130 and one end of the rotation shaft 103 of the throttle valve control device 100 illustrated in FIG. 2. FIG. 9 is an exploded perspective view of the rotor and the rotation shaft illustrated in FIG. 8.

For example, as illustrated in FIGS. 1 to 3, the gear cover 140 covers the throttle gear 111, the intermediate gear 112, the motor gear 113, and the like, and is fixed to the throttle body 101 by a clip provided on the throttle body 101. As illustrated in FIG. 6, a space between the gear cover 140 and the throttle body 101 is sealed by a sealing member 141 disposed in a groove formed along an opening edge of the gear cover 140.

The gear cover 140 has, for example, positioning protrusions 142, 143, and 144 illustrated in FIG. 6. The gear cover 140 is put on the throttle body 101 so as to align the positioning protrusions 142, 143, and 144 with wall parts 101g, 101h, and 101i of the throttle body 101 illustrated in FIG. 5, respectively.

As illustrated in FIG. 8, this enables the rotor 130 fixed to the one end of the rotation shaft 103 and the fixed board 150 fixed to the gear cover 140 to be opposed to each other in a predetermined positional relationship. In FIG. 8, components around the rotor 130 such as the throttle gear 111, the nut 107, the default lever 122, and the default spring 123 are not illustrated.

For example, as illustrated in FIGS. 2 and 6, the fixed board 150 is fixed to the inside of the gear cover 140 with an adhesive, and a coating agent is applied to the surface of the fixed board to be protected from wear debris and corrosive gas of the reduction gear mechanism. For example, as illustrated in FIG. 7, the fixed board 150 includes four energization conductors 151, a plurality of signal detection conductors 152, two microcomputers 153, two signal output terminals 154 and 155, one power supply terminal 156, and one ground terminal 157.

For example, as illustrated in FIG. 7, the four energization conductors 151 are provided so as to draw a circle on the fixed board 150. The plurality of signal detection conductors 152 extend radially inside the energization conductor 151, for example. In the example illustrated in FIG. 7, the signal detection conductor 152 outputs, for example, a three-phase AC signal whose phase is shifted by 120 degrees.

Each of the two microcomputers 153 has a drive control function and a signal processing function of an inductive rotation angle detection device. For example, each of the microcomputers 153 supplies a current supplied from the power supply terminal 156 to the energization conductor 151, and processes a three-phase AC current waveform generated in the signal detection conductor 152, thereby detecting a rotation position of an excitation conductor 131 of the rotor 130 illustrated in FIGS. 8 and 9. This enables detection of rotation angles of the rotation shaft 103 and the valve body 102 that rotate together with the rotor 130.

In addition, in the example illustrated in FIG. 7, the energization conductor 151, the signal detection conductor 152, and the microcomputer 153 constitute two sets of rotation angle detection devices having the same configuration. Of the two signal output terminals 154 and 155, one signal output terminal 154 outputs a detection signal of the first rotation angle detection device, and the other signal output terminal 155 outputs a detection signal of the second rotation angle detection device.

By comparing the signals output from the two sets of the rotation angle detection devices, it is possible to detect abnormality in each rotation angle detection device. In addition, when abnormality occurs in one of the rotation angle detection devices, the other rotation angle detection device can back up the rotation angle detection device in which the abnormality occurs. In addition, by disposing the power supply terminal 156 between the two signal output terminals 154 and 155, it is possible to prevent a short circuit between the signal output terminals 154 and 155 and accordingly prevent abnormality from occurring in both the rotation angle detection devices.

As illustrated in FIGS. 8 and 9, the rotor 130 has, for example, an excitation conductor 131, a flange part 132, a main body 133, an insertion hole 134, and a groove part 135. The rotation shaft 103 has, for example, an insertion part 103a and an enlarged diameter part 103b.

The excitation conductor 131 of the rotor 130 is, for example, a thin plate-like metal member as a whole, and has a regular shape in which three large-diameter arc parts and three small-diameter arc parts are alternately disposed at equal angles in a circumferential direction and connected by connecting parts extending in a radial direction. For example, the excitation conductor 131 is molded integrally with the resin-made flange part 132 of the rotor 130, is exposed on a surface of the flange part 132 opposed to the fixed board 150, and is disposed opposed to the energization conductor 151 and the signal detection conductor 152 of the fixed board 150.

The flange part 132 of the rotor 130 is, for example, a disk-shaped part molded integrally with the resin-made main body 133 and connected to one end of the main body 133. The flange part 132 has a diameter larger than a dimension of the main body 133 in a radial direction of the flange part 132, and the flange part 132 has an outer edge portion protruding outward from an outer peripheral surface of the main body 133. The flange part 132 has a single notch 132a at the outer edge portion on the radially outer side than one small-diameter arc part of the excitation conductor 131.

The main body 133 of the rotor 130 is a bottomed cylindrical part in which on a bottom surface on a side opposite to the flange part 132, the insertion hole 134 having an opening is formed. In addition, the main body 133 has the groove part 135 on the bottom surface. The outer peripheral surface of the main body 133 has, for example, a pair of partly cylindrical convex curved surfaces and a pair of flat surfaces formed on opposite sides of the pair of convex curved surfaces.

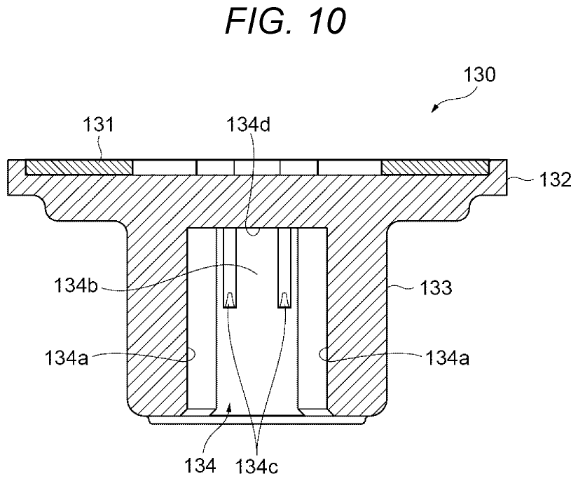

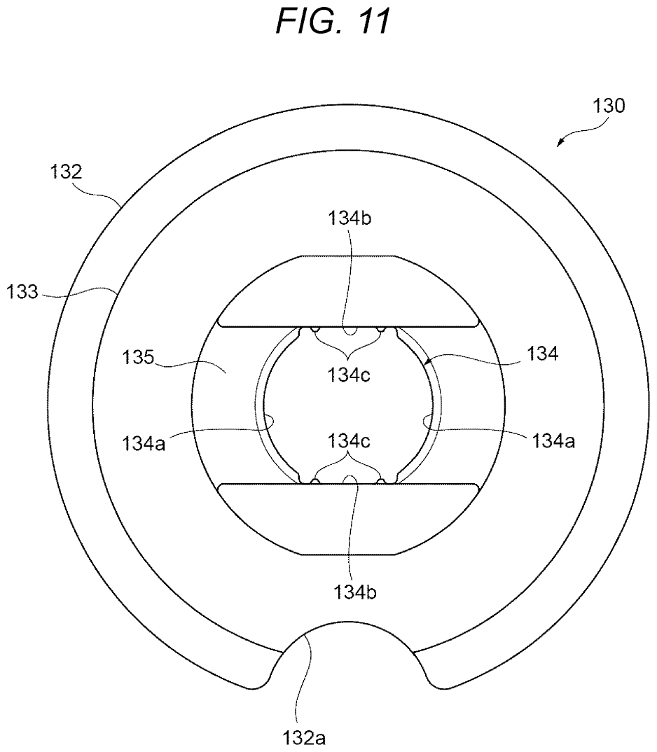

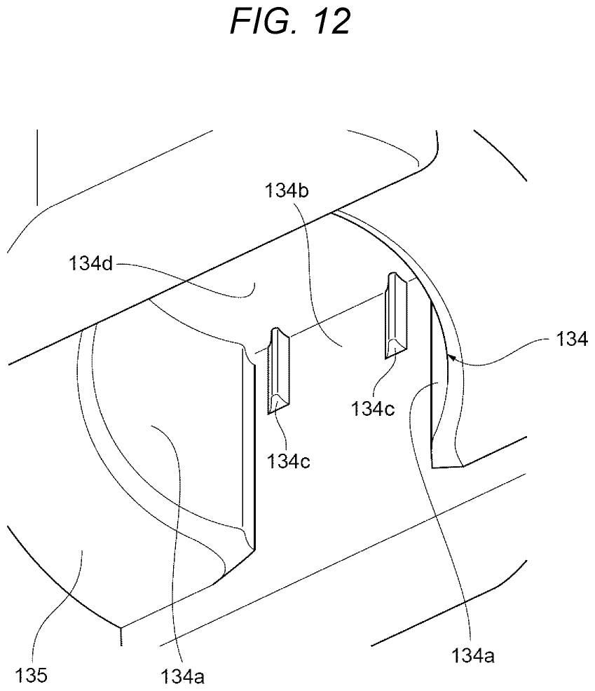

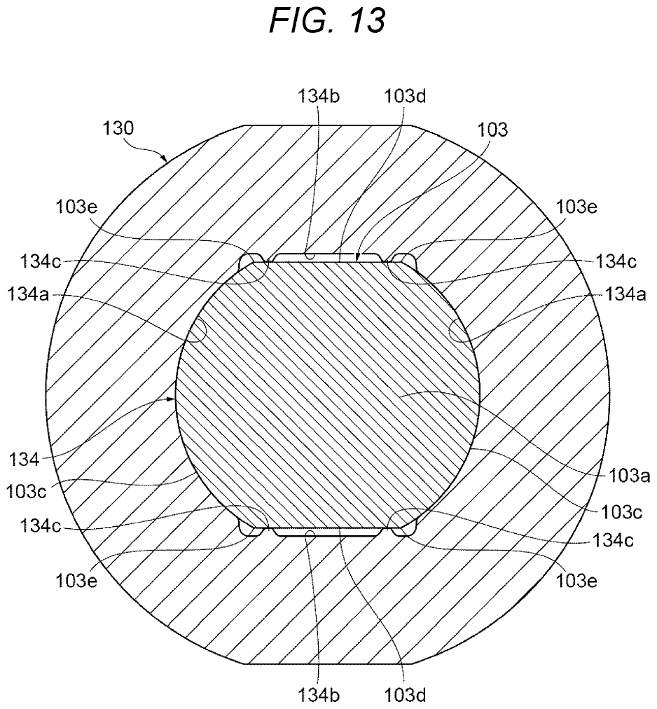

FIG. 10 is a cross-sectional view of the rotor 130 illustrated in FIG. 9. FIG. 11 is a bottom view of the rotor 130 illustrated in FIG. 9. FIG. 12 is a perspective view of the insertion hole 134 of the rotor 130 illustrated in FIG. 11. FIG. 13 is an enlarged cross-sectional view of the insertion hole 134 of the rotor 130 and the insertion part 103a of the rotation shaft 103 illustrated in FIG. 8.

In the throttle valve control device 100 and the press fit structure of the present embodiment, the rotor 130 and the rotation shaft 103 are integrally rotated by press-fitting and fixing the insertion part 103a provided at one end of the rotation shaft 103 into an insertion hole 134 provided in the rotor 130. As illustrated in FIGS. 9 and 13, an outer peripheral surface of the insertion part 103a of the rotation shaft 103 has, for example, a pair of convex curved surfaces 103c, a pair of flat surfaces 103d, and four ridge parts 103e.

The pair of convex curved surfaces 103c is a part of a columnar surface concentric with the rotation shaft 103. The paired convex curved surfaces 103c are provided, for example, to be symmetric with respect to a plane perpendicular to the pair of flat surfaces 103d and including a central axis of the rotation shaft 103. The pair of flat surfaces 103d is a flat surface provided between the pair of convex curved surfaces 103c. The pair of flat surfaces 103d is, for example, parallel to each other.

In the example illustrated in FIG. 9, each of the pair of convex curved surfaces 103c and the pair of flat surfaces 103d extends in an axial direction of the rotation shaft 103 from a distal end of the chamfered insertion part 103a to the enlarged diameter part 103b having a diameter larger than that of the insertion part 103a. As illustrated in FIG. 13, the ridge part 103e is a corner portion formed at a boundary between the flat surface 103d and the convex curved surface 103c, and is formed at opposite ends in a circumferential direction of each convex curved surface 103c, i.e., at opposite ends in a width direction of each flat surface 103d.

As illustrated in FIGS. 10 to 12, the insertion hole 134 of the rotor 130 opens, for example, at the center of a bottom surface of the main body 133 on the side opposite to an end connected to the flange part 132 of the main body 133. As illustrated in FIGS. 11 and 12, the groove part 135 is provided so as to cross the bottom surface of the main body 133, and the insertion hole 134 is opened in a bottom surface of the groove 135. The insertion hole 134 has, for example, a depth in a central axis direction of the substantially cylindrical main body 133 having the pair of flat surfaces, and has a bottom surface 134d at the end to which the flange part 132 of the main body 133 is connected.

As illustrated in FIGS. 10 to 13, an inner peripheral surface of the insertion hole 134 of the rotor 130 has a pair of concave curved surfaces 134a, a pair of recesses 134b, and a plurality of rotation prevention parts 134c.

Each concave curved surface 134a is, for example, a part of a cylindrical surface fitted with each of the pair of convex curved surfaces 103c of the insertion part 103a of the rotation shaft 103. In other words, since a radius of the concave curved surface 134a of the insertion hole 134 is substantially equal to, for example, a radius of the convex curved surface 103c of the insertion part 103a to have a negative tolerance, the insertion part 103a can be press-fitted and fixed to the insertion hole 134.

As illustrated in FIG. 13, the recess 134b of the insertion hole 134 forms a space in between with the pair of flat surfaces 103d of the insertion part 103a and around each rotation prevention part 134c in a state where the insertion part 103a is press-fitted into the insertion hole 134. In addition, each rotation prevention part 134c of the insertion hole 134 protrudes from a bottom surface of each recess 134b and is in contact with each flat surface 103d of the insertion part 103a.

The inner peripheral surface of the insertion hole 134 has, for example, the pair of rotation prevention parts 134c at opposite ends in a width direction of each of the recesses 134b adjacent to the pair of concave curved surfaces 134a, the pair of rotation prevention parts being spaced apart from the pair of concave curved surface 134a. The number of the rotation prevention parts 134c provided at the bottom of each recess 134b is not limited to two, and may be, for example, one or three or more.

For example, as illustrated in FIGS. 10 and 12, the pair of rotation prevention parts 134c provided in the respective recesses 134b of the insertion hole 134 extend in a depth direction of the insertion hole 134 from a bottom of the insertion hole 134 to the middle of the inner peripheral surface. A length of the rotation prevention part 134c in the depth direction of the insertion hole 134 is, for example, ½ or less of the depth of the insertion hole 134.

In addition, a height of each rotation prevention part 134c protruding from the bottom surface of each recess 134b may be, for example, higher than a depth of the recess 134b in a state before the insertion part 103a is press-fitted into the insertion hole 134, and may protrude from an opening of the recess 134b toward the inside of the insertion hole 134. In addition, as illustrated in FIGS. 10 and 12, a distal end surface of the rotation prevention part 134c on the side opposite to the bottom surface 134d in the depth direction of the insertion hole 134 is, for example, inclined so as to approach the bottom surface 134d of the insertion hole 134 as the distal end surface goes away from the bottom surface of the recess 134b.

With such a configuration, when the insertion part 103a of the rotation shaft 103 is press-fitted into the insertion hole 134 of the rotor 130, a distal end of the rotation prevention part 134c in a protruding direction is crushed by the flat surface 103d of the insertion part 103a and elastically or plastically deformed. As a result, the rotation prevention part 134c of the insertion hole 134 of the rotor 130 is pressed against the flat surface 103d of the insertion part 103a, thereby more reliably preventing relative rotation between the insertion part 103a and the rotor 130.

The bottom surfaces of the pair of recesses 134b of the insertion hole 134 are, for example, flat surfaces parallel to a central axis of the insertion hole 134 and parallel to each other as illustrated in FIGS. 10 and 11. In addition, as illustrated in FIG. 12, the recess 134b is continuously provided along the depth direction of the insertion hole 134 from the bottom surface 134d of the insertion hole 134 to an opening, for example. In addition, as illustrated in FIG. 13, when the insertion part 103a is press-fitted into the insertion hole 134, the bottom surfaces of the pair of recesses 134b of the insertion hole 134 are opposed to the pair of flat surfaces 103d of the insertion part 103a with a predetermined gap therebetween.

With such a configuration, when the insertion part 103a of the rotation shaft 103 is press-fitted into the insertion hole 134 of the rotor 130, air in the insertion hole 134 escapes to the outside through the gap between the recess 134b of the insertion hole 134 and the flat surface 103d of the insertion part 103a. Therefore, the insertion part 103a of the rotation shaft 103 can be reliably press-fitted deep into the insertion hole 134 of the rotor 130. When the distal end of the insertion part 103a is chamfered, the insertion part 103a is easily press-fitted into the insertion hole 134 of the rotor 130, and damage to the inner peripheral surface of the insertion hole 134 is prevented.

In addition, as illustrated in FIG. 13, in a cross section orthogonal to the depth direction of the insertion hole 134, a width of each recess 134b is larger than a width of the flat surface 103d of the insertion part 103a, for example. As a result, opposite ends in a width direction of each recess 134b are positioned on the pair of convex curved surfaces 103c on the outer side in the width direction than the ridge parts 103e at the opposite ends of the flat surface 103d of the insertion part 103a in the state where the insertion part 103a is being press-fitted into the insertion hole 134. With such a configuration, in the state where the insertion part 103a of the rotation shaft 103 is being press-fitted into the insertion hole 134 of the rotor 130, a space is formed around the ridge part 103e of the insertion part 103a by the recess 134b of the insertion hole 134.

In the following, functions of the throttle valve control device 100 and the press fit structure of the present embodiment will be described.

As described above, the throttle valve control device 100 of the present embodiment includes the valve body 102, the rotation shaft 103 that rotates the valve body 102, and the rotor 130 that rotates integrally with the rotation shaft 103. In the throttle valve control device 100, as described above, the insertion part 103a provided at one end of the rotation shaft 103 is press-fitted and fixed to the insertion hole 134 provided in the rotor 130. The outer peripheral surface of the insertion part 103a has the pair of convex curved surfaces 103c which is a part of the columnar surface concentric with the rotation shaft 103, the pair of flat surfaces 103d provided between the pair of convex curved surfaces 103c, and the ridge parts 103e formed at the boundaries between the flat surfaces 103d and the convex curved surfaces 103c. The inner peripheral surface of the insertion hole 134 of the rotor 130 has the pair of concave curved surfaces 134a, the pair of recesses 134b, and the plurality of rotation prevention parts 134c. The pair of concave curved surfaces 134a is fitted with the pair of convex curved surfaces 103c of the insertion part 103a. The pair of recesses 134b forms a space in between with the pair of flat surfaces 103d of the insertion part 103a and around each ridge part 103e. The rotation prevention part 134c protrudes from the bottom surface of each recess 134b and is in contact with each flat surface 103d of the insertion part 103a.

With such a configuration, according to the throttle valve control device 100 of the present embodiment, the insertion part 103a at one end of the rotation shaft 103 can be press-fitted into the insertion hole 134 of the rotor 130 to fix the rotor 130 to the one end of the rotation shaft 103. More specifically, when the insertion part 103a is press-fitted into the insertion hole 134 of the rotor 130, the pair of convex curved surfaces 103c of the insertion part 103a and the pair of concave curved surfaces 134a of the insertion hole 134 of the rotor 130 are fitted with each other. In addition, the rotation prevention part 134c protruding from the bottom surface of each recess 134b of the insertion hole 134 of the rotor 130 comes into contact with each flat surface 103d of the insertion part 103a, thereby preventing the relative rotation between the rotation shaft 103 and the rotor 130. As a result, the rotor 130 is fixed to the one end of the rotation shaft 103.

Furthermore, a space can be formed around the ridge parts 103e by the pair of recesses 134b provided on the inner peripheral surface of the insertion hole 134 of the rotor 130. As a result, it is possible to prevent the ridge part 103e, which is a corner portion formed between the convex curved surface 103c and the flat surface 103d of the insertion part 103a, from damaging the inner peripheral surface of the insertion hole 134 of the rotor 130. In addition, since the space is formed around the ridge part 103e of the insertion part 103a, the ridge part 103e of the insertion part 103a is prevented from digging into the inner peripheral surface of the insertion hole 134 of the rotor 130, thereby preventing concentration of stress on the inner peripheral surface of the insertion hole 134.

Furthermore, since the space is formed between each recess 134b of the insertion hole 134 of the rotor 130 and each flat surface 103d of the insertion part 103a, load and stress acting on the inner peripheral surface of the insertion hole 134 of the rotor 130 from the flat surface 103d of the insertion part 103a are reduced. In addition, it is possible to relax stress generated when the rotation prevention part 134c of the insertion hole 134 of the rotor 130 is crushed by the flat surface 103d of the insertion part 103a. Therefore, according to the throttle valve control device 100 of the present embodiment, it is possible to relax the stress acting on the rotor 130 into which the rotation shaft 103 is press-fitted.

Also in the throttle valve control device 100 of the present embodiment, the inner peripheral surface of the insertion hole 134 has the pair of rotation prevention parts 134c provided at opposite ends of the bottom surface of each recess 134b adjacent to the pair of concave curved surfaces 134a at intervals from the pair of insertion holes 134 and extending in the depth direction of the insertion hole 134 from the bottom of the insertion hole 134 to the middle of the inner peripheral surface.

With such a configuration, it is possible to form a gap between each rotation prevention part 134c of the insertion hole 134 of the rotor 130 and each ridge part 103e of the insertion part 103a. In addition, in each flat surface 103d of the insertion part 103a, opposite ends in the width direction in the vicinity of the ridge parts 103e can be supported by the pair of rotation prevention parts 134c provided in each recess 134b of the insertion hole 134 of the rotor 130.

As a result, the relative rotation between the insertion part 103a of the rotation shaft 103 and the rotor 130 can be more reliably prevented. In addition, a space can be formed between the pair of rotation prevention parts 134c provided in each recess 134b of the insertion hole 134 of the rotor 130. As a result, it is possible to more effectively reduce the load and stress acting on the inner peripheral surface of the insertion hole 134 of the rotor 130 from the pair of flat surfaces 103d of the insertion part 103a.

Furthermore, the pair of rotation prevention parts 134c provided in the respective recesses 134b of the insertion hole 134 of the rotor 130 extends in the depth direction of the insertion hole 134 from the bottom of the insertion hole 134 to the middle of the inner peripheral surface. As a result, when the insertion part 103a of the rotation shaft 103 is press-fitted into the insertion hole 134 of the rotor 130, the flat surface 103d of the insertion part 103a and each rotation prevention part 134c of the insertion hole 134 do not come into contact with each other halfway in the depth direction from the opening of the insertion hole 134. This facilitates press-fitting of the insertion part 103a of the rotation shaft 103 into the insertion hole 134 of the rotor 130. Furthermore, when the insertion part 103a is press-fitted from the middle of the inner peripheral surface to the bottom of the insertion hole 134 in the depth direction of the insertion hole, the flat surface 103d of the insertion part 103a and each rotation prevention part 134c of the insertion hole 134 come into contact with each other, thereby preventing the relative rotation between the rotation shaft 103 and the rotor 130.

The throttle valve control device 100 of the present embodiment further includes the throttle gear 111 that rotates the rotation shaft 103. Then, the rotation shaft 103 has the enlarged diameter part 103b provided adjacent to the insertion part 103a at a position closer to the valve body 102 than to the insertion part 103a and having an outer diameter larger than that of the insertion part 103a. Then, the throttle gear 111 has the attachment hole into which the enlarged diameter part 103b of the rotation shaft 103 is press-fitted.

With such a configuration, when fixing the throttle gear 111 to the rotation shaft 103, the throttle valve control device 100 of the present embodiment can insert the insertion part 103a having a smaller diameter than the enlarged diameter part 103b of the rotation shaft 103 into the attachment hole of the throttle gear 111. Then, the throttle gear 111 is guided by the insertion part 103a, so that the enlarged diameter part 103b of the rotation shaft 103 can be press-fitted into the attachment hole of the throttle gear 111. Similarly, the nut 107 can be guided by the insertion part 103a to screw the nut 107 into the screw of the enlarged diameter part 103b of the rotation shaft 103.

In addition, the throttle valve control device 100 of the present embodiment includes the excitation conductor 131 provided in the rotor 130 and the fixed board 150 opposed to the rotor 130. Furthermore, the throttle valve control device 100 further includes the annular energization conductor 151 provided on the fixed board 150 and opposed to the excitation conductor 131, and the signal detection conductor 152 provided on the fixed board 150 and radially extending inside the energization conductor 151. In addition, the rotor 130 has the main body 133 provided with the insertion hole 134, and the disk-shaped flange part 132 coupled to one end of the main body 133 and provided with the excitation conductor 131. Then, the flange part 132 has, at an outer edge portion on the radially outer side than the excitation conductor 131, a single notch 132a.

With such a configuration, at the time of manufacturing the throttle valve control device 100, for example, the single notch 132a provided in the flange part 132 of the rotor 130 can be detected by a laser detector to determine whether a press-fitting direction of the rotor 130 is good or bad. As a result, the rotor 130 can be attached to the insertion part 103a of the rotation shaft 103 in a predetermined direction.

In addition, the height of the excitation conductor 131 can be adjusted by press-fitting the insertion part 103a into the insertion hole 134 of the rotor 130 in a state where the rotation shaft 103 is assembled to the throttle valve control device 100. As a result, a clearance between the excitation conductor 131, and the energization conductor 151 and the signal detection conductor 152 can be accurately adjusted, and a highly accurate inductive throttle sensor can be configured. Note that a full open value and a full closing value of this throttle sensor can be decided, for example, by the default screw 124 and the fully closing screw 125 that define a rotatable angle range of the throttle gear 111.

In addition, in the press fit structure of the present embodiment, the insertion part 103a provided at one end of the rotation shaft 103 is press-fitted and fixed to the insertion hole 134 of the rotor 130. The outer peripheral surface of the insertion part 103a has the pair of convex curved surfaces 103c which is a part of the columnar surface concentric with the rotation shaft 103, the pair of flat surfaces 103d provided between the pair of convex curved surfaces 103c, and the ridge parts 103e formed at the boundaries between the flat surfaces 103d and the convex curved surfaces 103c. The inner peripheral surface of the insertion hole 134 of the rotor 130 has the pair of concave curved surfaces 134a, the pair of recesses 134b, and the plurality of rotation prevention parts 134c. The pair of concave curved surfaces 134a is fitted with the pair of convex curved surfaces 103c of the insertion part 103a. The pair of recesses 134b forms a space in between with the pair of flat surfaces 103d of the insertion part 103a and around each ridge part 103e. Each rotation prevention part 134c protrudes from the bottom surface of each recess 134b and is in contact with each flat surface 103d of the insertion part 103a.

With such a configuration, according to the press fit structure of the present embodiment, similarly to the throttle valve control device 100 described above, the insertion part 103a at one end of the rotation shaft 103 can be press-fitted into the insertion hole 134 of the rotor 130 to fix the rotor 130 to one end of the rotation shaft 103. Furthermore, similarly to the throttle valve control device 100 described above, damage and stress concentration on the inner peripheral surface of the insertion hole 134 of the rotor 130 due to the ridge parts 103e of the insertion part 103a are prevented, thereby reducing the load and stress acting on the inner peripheral surface of the insertion hole 134. Therefore, according to the press fit structure of the present embodiment, it is possible to relax the stress acting on the rotor 130 into which the rotation shaft 103 is press-fitted.

Furthermore, in the throttle valve control device 100 and the press fit structure of the present embodiment, the rotor 130 does not have a metal inserter for press-fitting and fixing the rotation shaft 103, and does not have a through hole penetrating the rotor 130 in the axial direction either. As a result, for example, static electricity generated from a machine constituting an engine control system is prevented from being discharged to the fixed board 150 via the metal inserter. Furthermore, a press-fitting failure caused by a variation in a dimensional tolerance between the rotation shaft 103 and the metal inserter is prevented, thereby enabling a press-fitting load to be made uniform when the insertion part 103a of the rotation shaft 103 is press-fitted into the insertion hole 134 of the rotor 130. In addition, the number of components of the rotor 130 can be reduced, resulting in improving dimensional accuracy of the resin-made rotor 130.

Although the embodiments of the throttle valve control device and the press fit structure according to the present disclosure have been described above in detail with reference to the drawings, the specific configuration is not limited to these embodiments, and design changes and the like without departing from the gist of the present disclosure are included in the present disclosure. The press fit structure according to the present disclosure is applicable to, for example, an accelerator position sensor, and a rotation angle sensor such as a movable blade control actuator of a turbocharger, a gear shift actuator, and a switching actuator for four-wheel drive/two-wheel drive.

### REFERENCE SIGNS LIST

100 throttle valve control device
102 valve body
103 rotation shaft
103a insertion part
103b enlarged diameter part
103c convex curved surface
103d flat surface
103e ridge part
111 throttle gear
130 rotor
131 excitation conductor
132 flange part
132a notch
133 main body
134 insertion hole
134a concave curved surface
134b recess
134c rotation prevention part
150 fixed board
151 energization conductor
152 signal detection conductor

1. A throttle valve control device comprising: a valve body;
a rotation shaft that rotates the valve body; and a rotor that rotates integrally with the rotation shaft, in which an insertion part provided at one end of the rotation shaft is press-fitted and fixed to an insertion hole provided in the rotor,
wherein an outer peripheral surface of the insertion part has a pair of convex curved surfaces which is a part of a columnar surface concentric with the rotation shaft, a pair of flat surfaces provided between the pair of convex curved surfaces, and ridge parts formed at boundaries between the flat surfaces and the convex curved surfaces, and
an inner peripheral surface of the insertion hole has a pair of concave curved surfaces fitted with the pair of convex curved surfaces of the insertion part, a pair of recesses forming a space in between with the pair of flat surfaces of the insertion part and around each of the ridge parts, and a rotation prevention part protruding from a bottom surface of each of the recesses and in contact with each of the flat surfaces of the insertion part.

2. The throttle valve control device according to claim 1, wherein the inner peripheral surface of the insertion hole has a pair of the rotation prevention parts provided at opposite ends of the bottom surface of the recess adjacent to the pair of concave curved surfaces at intervals from the pair of concave curved surfaces and extending in a depth direction of the insertion hole from a bottom of the insertion hole to a middle of the inner peripheral surface.

3. The throttle valve control device according to claim 1, further comprising a throttle gear that rotates the rotation shaft,
wherein the rotation shaft has an enlarged diameter part provided adjacent to the insertion part at a position closer to the valve body than to the insertion part and having an outer diameter larger than an outer diameter of the insertion part, and
the throttle gear has an attachment hole into which the enlarged diameter part of the rotation shaft is press-fitted.

4. The throttle valve control device according to claim 1, further comprising:
an excitation conductor provided in the rotor; a fixed board opposed to the rotor; an annular energization conductor provided on the fixed board and opposed to the excitation conductor; and a signal detection conductor provided on the fixed board and radially extending inside the energization conductor,
wherein the rotor has a main body provided with the insertion hole, and a disk-shaped flange part coupled to one end of the main body and provided with the excitation conductor,
the flange part having, at an outer edge portion on a radially outer side than the excitation conductor, a single notch.

5. A press fit structure in which an insertion part provided at one end of a rotation shaft is press-fitted and fixed to an insertion hole of a rotor, wherein
an outer peripheral surface of the insertion part has a pair of convex curved surfaces which is a part of a columnar surface concentric with the rotation shaft, a pair of flat surfaces provided between the pair of convex curved surfaces, and ridge parts formed at boundaries between the flat surfaces and the convex curved surfaces, and
an inner peripheral surface of the insertion hole has a pair of concave curved surfaces fitted with the pair of convex curved surfaces of the insertion part, a pair of recesses forming a space in between with the pair of flat surfaces of the insertion part and around each of the ridge parts, and a rotation prevention part protruding from a bottom surface of each of the recesses and in contact with each of the flat surfaces of the insertion part.
